(19) United States
(12) Patent Application Publication
(10) Pub. No.: US 2012/0053725 A1
(43) Pub. Date: Mar. 1, 2012

(54) Retail Merchandise Dispensing System

(75) Inventors: Joerg Niederhuefner, Altenmedingen (DE); Stanley C. Valiulis, Rockford, IL (US)

(73) Assignee: SOUTHERN IMPERIAL, INC., Rockford, IL (US)

(21) Appl. No.: 13/217,332

(22) Filed: Aug. 25, 2011

Related U.S. Application Data
(60) Provisional application No. 61/377,304, filed on Aug. 26, 2010.

(51) Int. Cl. G06F 17/00; B65G 59/00; B23P 11/00; B65D 83/00

(52) U.S. Cl. 700/241; 221/283; 221/279; 221/191; 29/428

(57) ABSTRACT

A retail merchandise dispensing system is provided. The retail merchandise dispensing system includes at least one dispensing unit. The dispensing unit has an input interface to facilitate the purchase of items from the retail merchandise dispensing system. The dispensing unit or groups of dispensing units can be fixedly mounted in a retail environment using various mounting bracket configurations. The dispensing unit or groups of dispensing units also communicate with an inventory management system. The inventory management system is configured to track inventory levels, communicate with various security systems, and communicated remotely with store employees via a mobile device.

### CROSS-REFERENCE TO RELATED PATENT APPLICATIONS

This patent application claims the benefit of U.S. Provisional Patent Application No. 61/377,304, filed Aug. 26, 2010, the entire teachings and disclosure of which are incorporated herein by reference thereto.

### FIELD OF THE INVENTION

This invention generally relates to retail display systems and more specifically to retail display systems designed for enhanced loss prevention.

### BACKGROUND OF THE INVENTION

Retail theft continues to be a problem in the retail industry. Thieves may steal a single item, or steal multiple items in a single act, often referred to as “sweeping.” In either case, the retailer loses revenue.

Retailers must compensate for this loss of revenue. In many cases, retailers increase the price of merchandise offered to paying customers. In addition or in the alternative, retailers also tend to compensate for a loss in revenue due to retail theft by reducing their overall operating costs, which unfortunately can mean less employees and/or lower wages and other benefits.

Various attempts have been made to reduce “shrinkage” or the amount of inventory lost due to retail theft. Many retail display systems now incorporate some form of loss prevention to inhibit a thief s ability to “sweep” items from a retail display. Unfortunately, these systems are still vulnerable to retail theft, even with their enhanced loss prevention functionality because the merchandise is still generally exposed such that single or multiple items may be removed from the retail display system.

As a result, there is a need for a retail display system that reduces or eliminates the threat of retail theft by reducing the exposure of the merchandise carried therein.

The invention provides such a retail display system. These and other advantages of the invention, as well as additional inventive features, will be apparent from the description of the invention provided herein.

### BRIEF SUMMARY OF THE INVENTION

In view of the above, embodiments of the present invention provide a retail merchandise dispensing system that overcomes existing problems in the art. More particularly, embodiments of the present invention provide a new and improved retail merchandise dispensing system that maintains merchandise in one or more dispensing units. The merchandise contained therein is in a secured state. The one or more dispensing units can be mounted to an existing retail display. As a result, many preexisting retail displays may be converted so as to include one or more dispensing units thereon. The dispensing units allow a customer to select and purchase items carried by the dispensing units. Once purchased, the merchandise is transferred to a merchandise removal area so that the customer may retrieve the same.

In one embodiment, a retail merchandise dispensing system is provided. The retail merchandise dispensing system according to this embodiment includes a retail display and a plurality of dispensing units fixedly mounted to the retail display. An inventory management system is in electronic communication with the plurality of dispensing units. In another embodiment, the retail merchandise dispensing system further includes a biasing mechanism operable to bias retail merchandise out of a retail merchandise retention area of at least one of the plurality of dispensing units and into a merchandise removal area of the at least one dispensing unit.

In another embodiment, the inventory management system is in electronic communication with a security system. The inventory management system is operable to detect the unauthorized removal of merchandise from at least one of the plurality of dispensing units. In another embodiment, the inventory management system is operable to send a signal to the security system to generate an alarm. In another embodiment, the inventory management system is operable to send a signal to the security system to focus a camera on at least one of the plurality of dispensing units. In yet another embodiment, the inventory management system is operably connected to at least one other inventory management system.

In another embodiment, a retail merchandise dispensing unit is provided. The retail merchandise dispensing unit according to this embodiment includes a housing having an interior space for retention of retail merchandise therein. The dispensing unit also has an access door providing access to the interior space. The access door is configured to be selectively locked relative to the housing to prevent unauthorized access to the retail merchandise carried in the interior space. The retail merchandise dispensing unit also includes an input interface configured to receive customer input to effectuate a purchase of retail merchandise. A mounting arrangement is configured to fixedly mount the dispensing unit to a retail display.

In another embodiment, the mounting arrangement is configured to fixedly mount the dispensing unit to a pegboard. In another embodiment, the mounting arrangement is configured to fixedly mount the dispensing unit to a retail shelf. In yet another embodiment, the mounting arrangement is configured to fixedly mount the dispensing unit to a slat wall.

In another embodiment, the retail merchandise dispensing unit further includes a biasing mechanism to bias merchandise within the housing from a secured position to an unsecured position. In another embodiment, the retail merchandise is inaccessible by a customer in the secured position and accessible by a customer in the unsecured position. In another embodiment, the merchandise is in an interior space of the housing in the secured position, and in a merchandise removal compartment in the unsecured position. Access from the interior space to the merchandise removal compartment is allowed. However, access form the merchandise removal compartment to the interior space is prevented.

In another embodiment, a loss prevention retail display is provided. A loss prevention retail display according to this embodiment includes a retail display structure for supporting a retail merchandise retention area. The retail merchandise retention area is configured to carry retail merchandise therein. The loss prevention retail display also includes an input system configured to receive a customer input. A biasing mechanism is operable to bias retail merchandise out of the retail merchandise retention area and into a merchandise removal area in response to the customer input.

In another embodiment, a method for configuring a retail merchandise environment with a retail merchandise dispensing system is provided. The method according to this embodiment includes the steps of mounting a dispensing unit of the merchandise display system to a preexisting retail display. In another embodiment, the step of mounting includes mounting the merchandise dispensing system in proximity to items of retail merchandise that are in an unsecured state. In another embodiment, the method further includes the step of removing retail merchandise containment structures from a location and placing a dispensing unit in the location of the retail display.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is an exemplary embodiment of a retail merchandise dispensing system situated on a retail shelf in a retail store;

FIG. 2 is a side view of a dispensing unit of the retail merchandise dispensing system of FIG. 1;

FIG. 3 is a partial exploded perspective view of a mounting configuration of the dispensing unit of FIG. 2;

FIG. 4 is a side view of another mounting configuration of the dispensing unit of FIG. 2;

FIG. 5 is a top view of another mounting configuration of multiple dispensing units;

FIG. 6 is a perspective view of a labeled item of retail merchandise carried by the retail merchandise dispensing system of FIG. 1;

FIG. 7 is a perspective view of another labeled item of retail merchandise carried by the retail merchandise dispensing system of FIG. 1;

FIG. 8 is a schematic view of various modes of communication of the retail dispensing system of FIG. 1;

FIG. 9 is a front view of the dispensing unit of FIG. 2 mounted to a pegboard; and

FIG. 10 is a front view of the dispensing unit of FIG. 2 mounted to a slatwall.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

Turning now to the drawings, there is illustrated a display mounted retail merchandise dispensing system having a plurality of dispensing units 12 situated on a retail shelf 10 and in proximity to other retail merchandise 8 in a typical retail environment. The dispensing units 12 are illustrated on a retail shelf 10 typically located inside a conventional retail store. While the following description will utilize such an exemplary environment in describing various features and functionality of embodiments of the present invention, such description should be taken by way of example and not by way of limitation. Indeed, the dispensing units 12 can be utilized in various retail environments, including but not limited to indoor and outdoor retail facilities, point of purchase displays, and other similar or dissimilar environments.

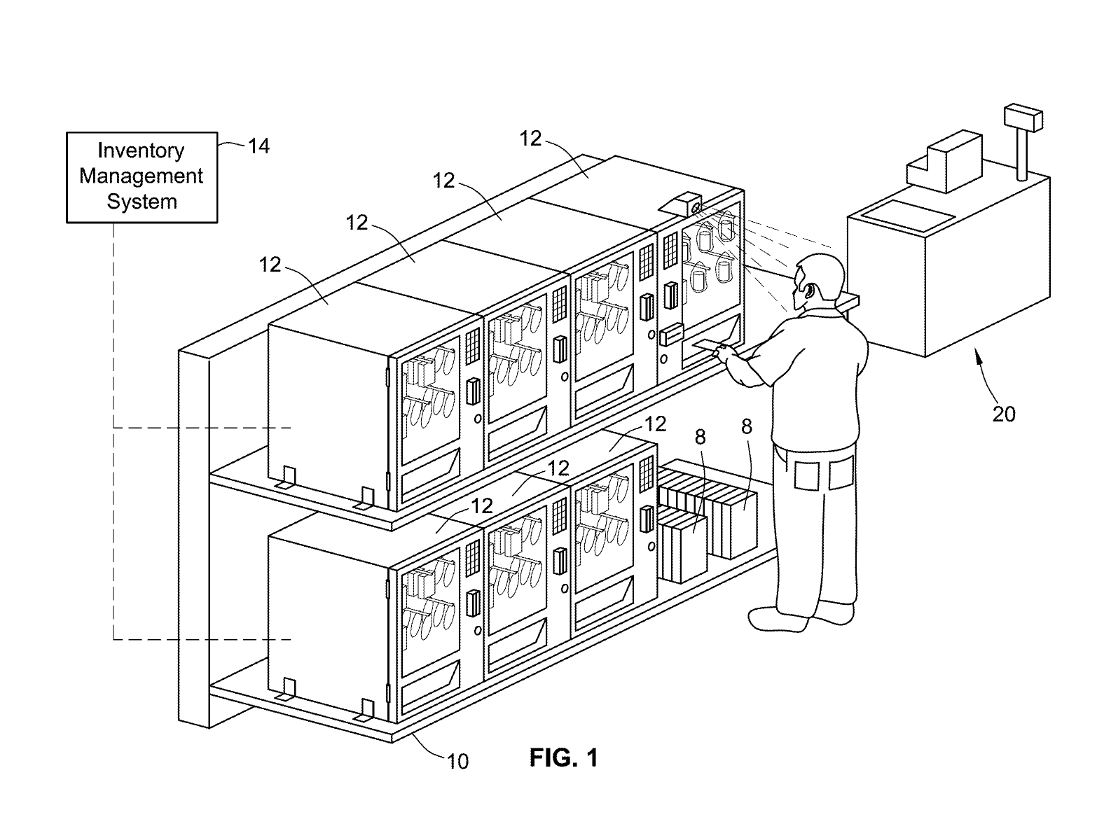

With reference to FIG. 1, a plurality of display units 12 are fixedly mounted to a retail shelf 10. Each dispensing unit 12 can carry a single type of retail merchandise, or can carry different types of retail merchandise therein. The dispensing units 12 are configured to allow a customer to visibly see, select, purchase, and remove merchandise contained therein.

The dispensing unit 12 presents product to a customer in a neat and organized manner while also preventing theft as the merchandise is contained therein until after it is purchased. Each dispensing unit is also configured to take various forms of currency, e.g. cash, coin, credit cards, debit cards, gift cards, etc. As will be explained in greater detail below, each dispensing unit 12 allows a customer to input information into the dispensing unit 12 to select an appropriate type and quantity of merchandise. Further, the retail environment can also include a traditional checkout counter 20 for the purchasing of unsecured merchandise, and/or for the scanning of secured merchandise that has already been purchased and removed from a dispensing unit 12. Scanning can be done to deactivate any additional security measures on the secured merchandise, or as an additional security measure.

Each dispensing unit 12 or groups of dispensing units 12 are also in communication with an inventory management system 14. The inventory management system 14 provides various functions such as inventory tracking, security, and other common functions performed manually in a retail environment. It will be recognized from the following, however, that in certain embodiments the inventory management system 14 may be omitted and embodiments of the invention therefore do not require the same.

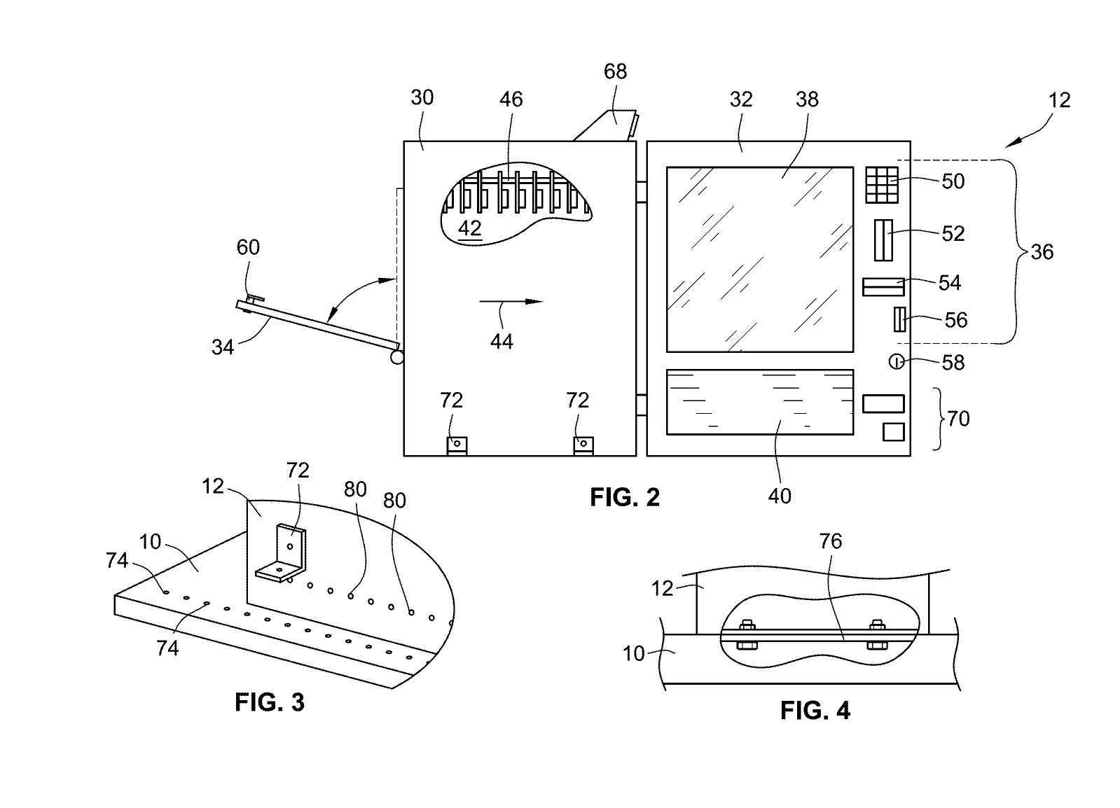

Turning now to FIG. 2, an exemplary embodiment of a dispensing unit 12 is illustrated. The dispensing unit 12 has a housing 30 for containing retail merchandise therein and front and rear doors 32, 34 for accessing an interior 42 of the housing 30. It is recognized that in other embodiments the dispensing unit 12 may be supplied with a single access door or more than the front and rear doors 32, 34 depending upon the size, type, and frequency of removal of retail merchandise carried by particular dispensing unit 12.

The front door 32 has an input interface 36. The input interface has a key pad 50 to allow a customer to input information regarding a particular item as well as a quantity thereof. The key pad 50 can carry a combination of alpha numeric characters as well as other symbols. The input interface also has a card reader 52. The card reader 52 can scan in information from credit cards, debit cards, gift cards, and identification cards where age or other identifying information is required prior to making a purchase of a particular item of retail merchandise.

Where photo identification is required for the purchase of a particular item, the dispensing unit 12 can in some embodiments incorporate a camera 68 that employs facial recognition technology to compare a customer's face with the picture contained on their photo identification after being scanned through the card reader 52.

The input interface 36 also has a currency feeder 54 and coin slot 56. The currency feeder 54 and coin slot 56 accept paper and coin currency to effectuate a given purchase. The dispensing unit 12 has a change dispenser 70 to dispense cash and coin change after a particular purchase is made.

Although the input interface 36 is mounted on the door 32, it is recognized that in other embodiments the input interface need not be mounted directly to the door 32 but otherwise mounted to the dispensing unit 12, e.g. mounted to the housing 30, or the shelf which the unit rests. Further, a single input interface 36 could control a plurality of dispensing units 12.

A window 38 and a merchandise removal compartment 40 are provided on the front door 32. The window 38 permits the easy viewing of merchandise contained within the dispensing unit 12. The merchandise is transferred to the merchandise removal compartment removal 40 after it has been purchased, and is accessible so that the customer may thereafter remove merchandise from the dispensing unit 12.

Store employees can load or unload a particular dispensing unit 12 via the front door 32 or the rear door 34, or a combination thereof. Merchandise carried by the dispensing unit 12 may be situated on a hook 46. In other embodiments, other retail systems may be employed, e.g. pusher systems, screw style hooks, shelves, etc. Whatever retail system employed, once a particular item or items of merchandise is purchased, the same is biased generally along direction 44 until it falls into the merchandise removal compartment 40 for retrieval by a customer.

Prior to being purchased, the merchandise is securely maintained within the housing 30 of the dispensing unit 12. More particularly, each of the front and rear doors 32, 34 employs a lock 58, 60 preventing unauthorized access to the merchandise carried by the dispensing unit 12 before it has been purchased. Also, the merchandise removal compartment 40 is generally segregated from the interior space 42 to prevent theft therefrom.

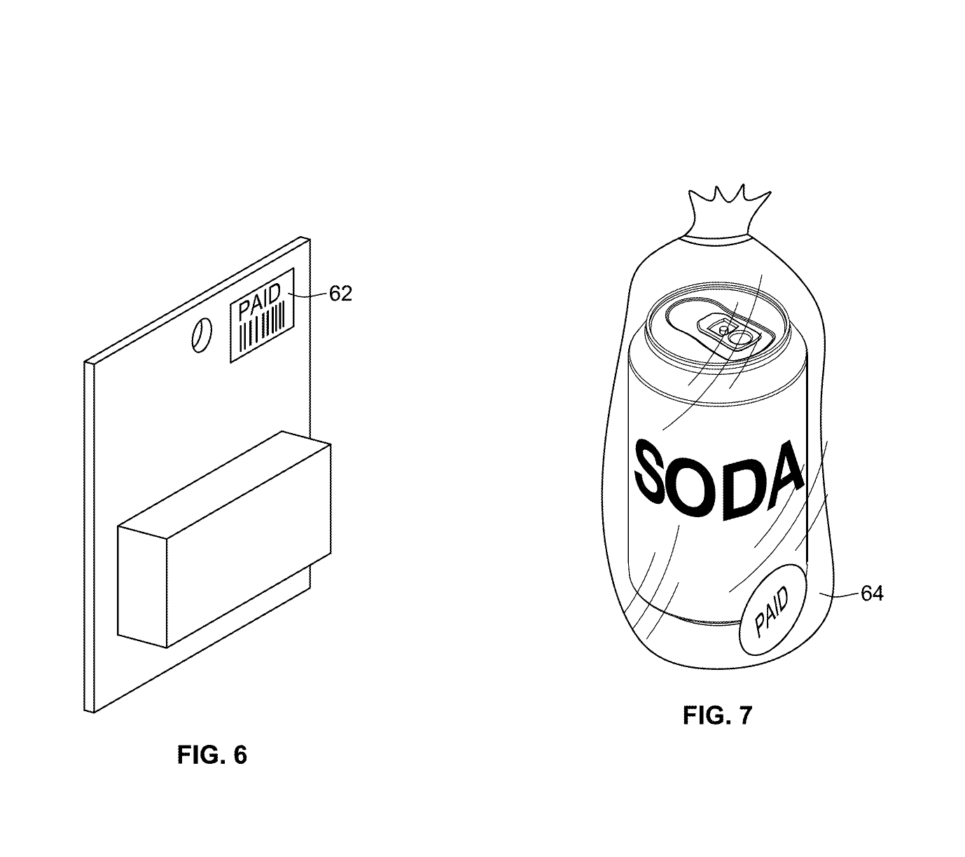

As a further security measure, the merchandise carried within the dispensing unit 12 can also be labeled in such a way as to indicate that it has been paid for after a customer has removed the merchandise from the dispensing unit 12. For example, and with reference to FIG. 6, the merchandise may be labeled with a label 62 that indicates that it has been paid for. The label 62 may be marked with the word “PAID” or additionally or in the alternative contain a UPC that may be scanned by a store employee as the customer exits the retail area.

Further, each piece of merchandise could include a security device that is deactivated as it transfers into or out of the merchandise removal compartment 40 (e.g. magnetically disabled strip, RFID strips, etc.). Indeed, the merchandise removal compartment 40 could incorporate an additional security deactivation device to deactivate a security measure such as an RFID strip affixed to the merchandise.

Alternatively, and with reference to FIG. 7, the merchandise may also be carried in a bag 64 that indicates that it has been paid for. The bag 64 may be marked with a label similar to that as illustrated in FIG. 6. As used herein, the aforementioned examples are generally “indicators” for indicating that a particular item has been paid for.

While the marking of merchandise carried by a particular dispensing unit 12 provides enhanced security and inventory control, such marking is not required to practice embodiments of the invention. Indeed, merchandise may also be placed unmarked in the dispensing units 12 for later purchase by a customer.

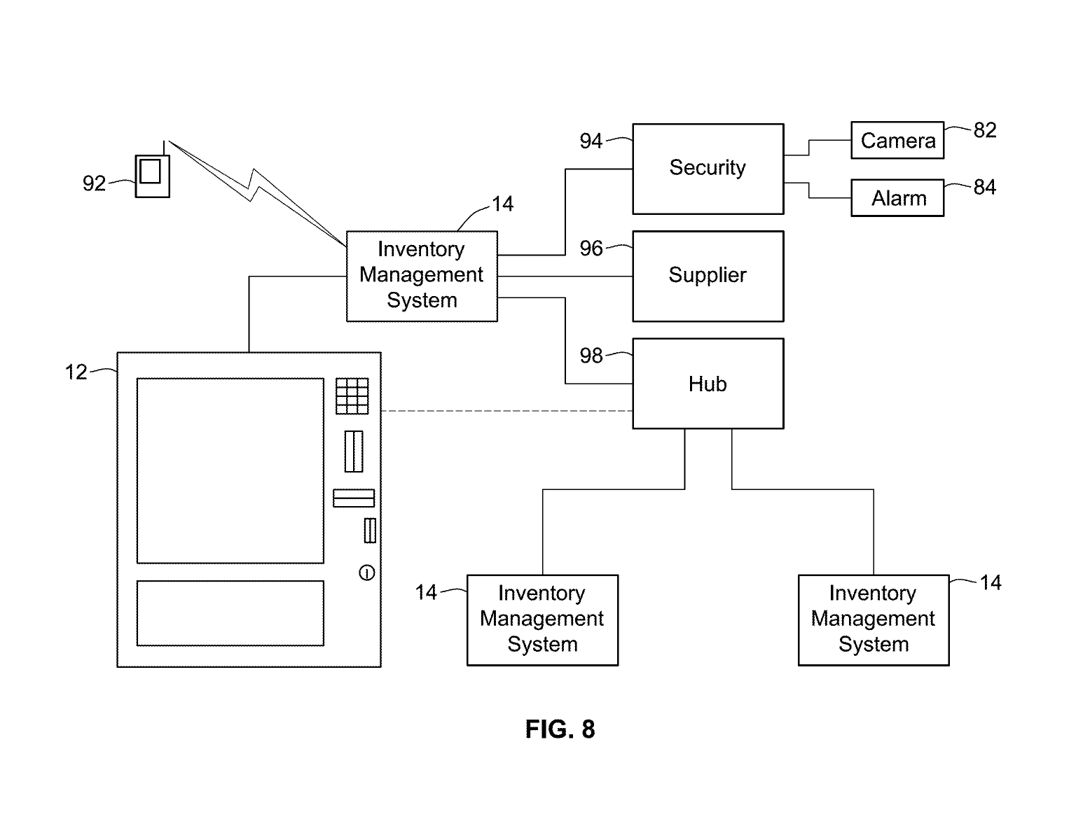

Referring now to FIG. 8, each dispensing unit 12 or groups of dispensing units 12 are in electronic communication with an inventory management system 14. Although schematically illustrated, it is recognized that various components can embody an inventory management system. For example, the inventory management system can be a software program installed on a workstation in a particular retail store.

The dispensing unit 12 can communicate with the inventory management system 14 wirelessly or via a wired connection. Additionally, each display unit or groups of display units 12 can communicate with an inventory management system 14 via a hub 98. The hub 98 can be embodied as an offsite server connecting the dispensing unit 12 to an inventory management system 14 or multiple inventory management systems 14 via the internet. Furthermore, the hub 98 can facilitate the communication between multiple inventory management systems 14 as illustrated.

A typical inventory management system 14 can perform a variety of functions. For example, the inventory management system 14 can communicate wirelessly with a handheld device such as a pager 92. A store employee carrying the pager 92 can receive data from the inventory management system 14 relating to security, inventory levels, or other similar information that will ensure the effective operation of the dispensing unit 12.

Additionally, the inventory management system 14 can communicate directly with a security system 94. The security system 94 can in turn communicate with in store video cameras 82 or alarm systems 89 in the event of a security breach as detected via the inventory management system 14.

In another advantageous embodiment, the inventory management system 14 can incorporate a customer loyalty program. That is, regular customers can be issued a loyalty card that is readable by the card reader 52 (see also FIG. 2). The loyalty card is associated with a unique customer identification number that is also saved in the inventory management system 14. When a customer desires to remove an item from the dispensing unit 12, they are first required to swipe their customer loyalty card in addition, or in the alternative, to tendering payment to the dispensing unit 12. The unique customer identification number of the loyalty card is then analyzed by the inventory management system 14 to ensure that the same has not been “locked out” from making purchases.

A unique customer identification number may be “locked out” in the event that the particular customer associated with the unique customer identification number has previously been apprehended for shoplifting (or attempting to shoplift) goods from the business utilizing the inventory management system 14. Once locked out, that particular customer will no longer be able to remove items from the dispensing unit 12, as their loyalty card will indicate a locked out condition.

It will be recognized that such a loyalty card program could also be used to control the amount of product in a certain time period a customer may purchase. As one example, certain over the counter drugs can only be purchased in limited quantities in any given time period based on governmental regulations. The inventory management system 14 could track the amount of such a product that is purchased and associate the same with the unique customer identification number. In the event the customer attempts to utilize the loyalty card to purchase more product in a given time period than regulations allow, the inventory management system 14 will prevent such a sale based on its recognition of the unique customer identification number associated with the subject loyalty card.

It will also be recognized that, because of the ability to network inventory management systems 14 situated at a plurality of stores together, a customer that has been locked out due to a shoplifting incident at one store would also be locked out at other stores that have access to the loyalty card lock out information by way of their networked inventory management systems 14.

Additionally, the dispensing unit 12 can be configured with sensors to detect the unauthorized removal of retail merchandise from the unit 12. The sensors may be touch sensors, motion sensors, light sensors, or other similar sensors, alone or in combination. Upon detection, the unit is operable and sends an alert signal to the inventory management system 14. When such a signal is sent, the inventory management system 14 in turn can alert the security system 94 to focus an in store camera 82 on that particular dispensing unit 12, and/or initiate an alarm 84. The alarm 84 can be audible, visual, or a combination of both.

In addition to providing enhanced security, the inventory management system 14 can also communicate directly with retail merchandise suppliers 96. In doing so, the inventory management system 14 can alert a particular supplier 96 of a need for more merchandise. Further, the inventory management system 14 can be configured to automatically order more merchandise from the supplier 96 upon detection of low inventory levels of a particular dispensing unit 12 or multiple dispensing units 12.

Still further, the inventory management system 14 can incorporate database functionality to log data relevant to retail stores. For example, the inventory management system 14 can track the frequency that a particular item is purchased during a particular time of year. The inventory management system 14 can maintain historical data on the purchasing and ordering of retail merchandise to further assist a retailer with proper inventory management.

Referring back to FIG. 3, each dispensing unit 12 can incorporate mounting brackets 72 to affix it to a retail shelf 10. The mounting bracket 72 can take a variety of forms. In the illustrated embodiment, the mounting bracket 72 mounts to a grouping of apertures 74 of a retail shelf 10 and also to apertures 80 of the dispensing unit 12.

Referring now to FIG. 4, a single dispensing unit 12 or multiple dispensing units 12 can mount to an underside of a retail shelf 10 using mounting brackets 76. Such a configuration provides enhanced security wherein it is more difficult to remove the dispensing unit 12 from the shelf 10 because the brackets 76 are generally hidden under the shelf 10.

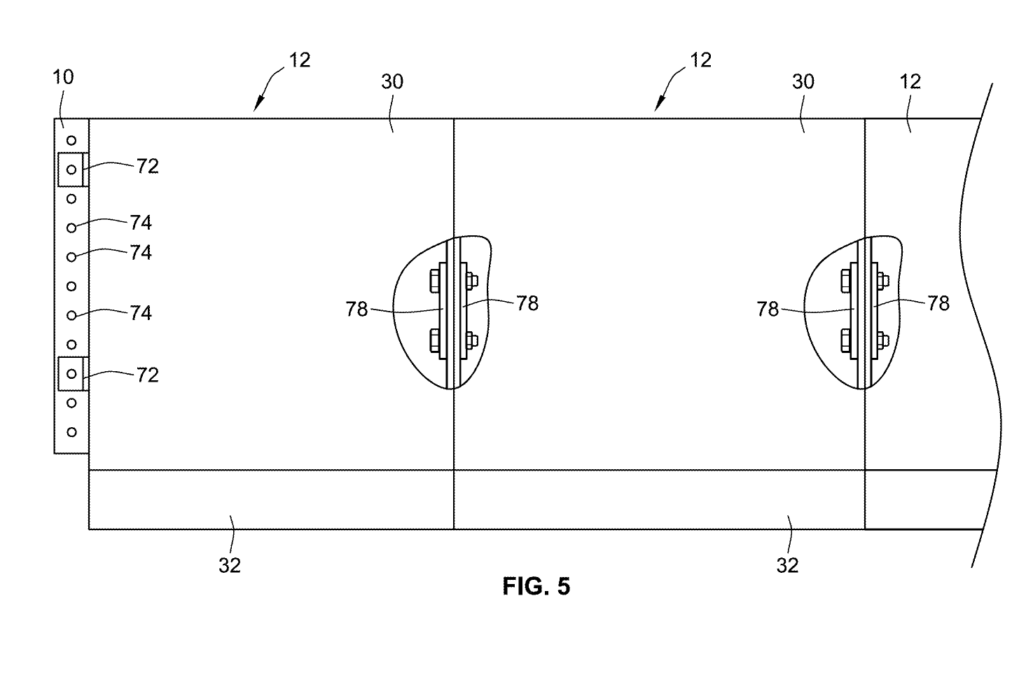

With reference now to FIG. 5, adjacent dispensing units 12 can be interlocked with one another using internal mounting brackets 78. As illustrated in FIG. 5, the internal mounting brackets 78 are disposed within the interior space 42 (see FIG. 2) so that access of the same requires access via the front or rear doors 32, 34 which as described above are ordinarily locked. As a result, in an instance where the external bracket 72 can be removed from a particular dispensing unit 12, the dispensing unit 12 will still be affixed to an adjacent dispensing unit 12 by way of the internal mounting bracket 78.

In further embodiments, the dispensing units 12 need not include a separate merchandise removal compartment 40. Once the merchandise is paid for, the door 32 could simply unlock, and the particular item of merchandise unlocked from the structure containing it within the interior space 42. Thereafter, the customer could remove the merchandise from the dispensing unit 12. After removal, the door 32 would re-lock.

It will be recognized from the forgoing that a variety of existing retail display structures can be quickly and easily converted to incorporate the dispensing units 12. For example, with reference to FIG. 1, an existing retail shelf 10 can be quickly reconfigured to contain one or more dispensing units 12. The resulting retail display thereafter presents both secured merchandise (contained in the dispensing unit 12) and unsecured merchandise 8 on the retail shelf 10.

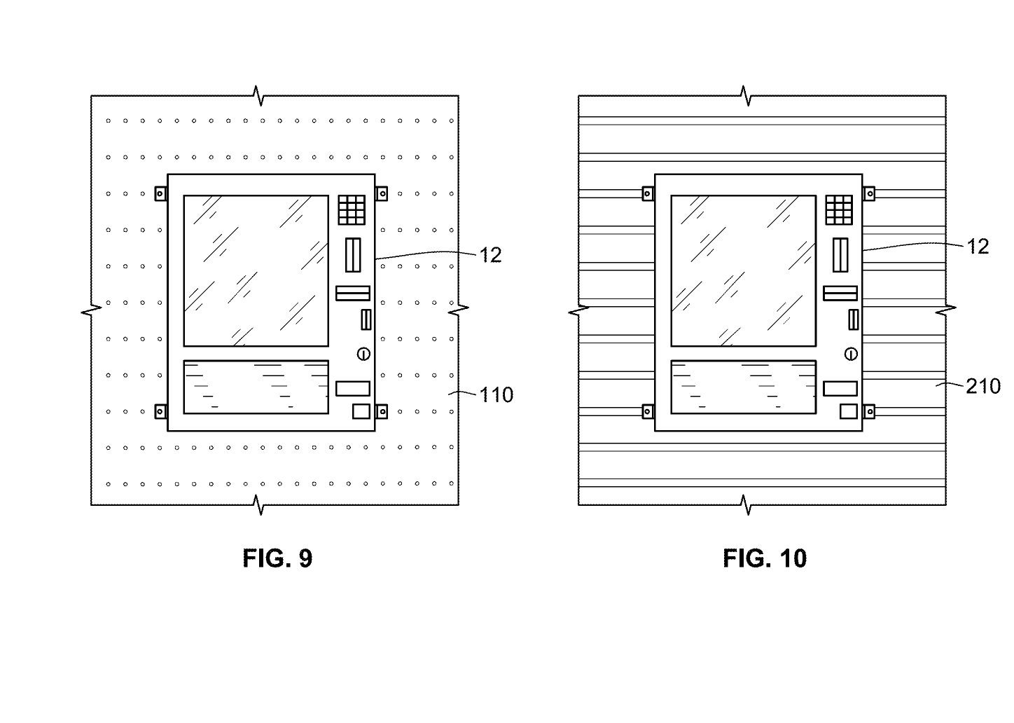

Turning now to FIG. 9, a single or multiple dispensing units 12 can also mount to a pegboard 110. In this configuration, the dispensing unit 12 can be located in proximity to other unsecured merchandise carried by hooks or other structures mounted to the peg board. Similarly, and with reference to FIG. 10, a single or multiple dispensing units 12 can also mount to a slatwall 210. Just as the retail shelf and pegboard configurations discussed above, in this configuration other unsecured merchandise can also be mounted to the slatwall 210.

As described herein, embodiments of the invention provide a retail display system that overcomes existing problems in the art. More particularly, embodiments of the present invention provide a retail display system that substantially reduces the exposure of retail merchandise prior to purchase.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A retail merchandise dispensing system, comprising:
a retail display;
a plurality of dispensing units fixedly mounted to the retail display; and
an inventory management system in electronic communication with the plurality of dispensing units.

2. The retail merchandise dispensing system of claim 1, further comprising a biasing mechanism operable to bias retail merchandise out of a retail merchandise retention area of at least one of the plurality of dispensing units and into a merchandise removal area of the at least one dispensing unit.

3. The retail merchandise dispensing system of claim 1 wherein the inventory management system is in electronic communication with a security system, and is operable to detect the unauthorized removal of merchandise from at least one of the plurality of dispensing units.

4. The retail merchandise dispensing system of claim 3 wherein the inventory management system is operable to send a signal to the security system to generate an alarm.

5. The retail merchandise dispensing system of claim 3 wherein the inventory management system is operable to send a signal to the security system to focus a camera on at least one of the plurality of dispensing units.

6. The retail merchandise system of claim 1 wherein the inventory management system is operably connected to at least one other inventory management system.

7. A retail merchandise dispensing unit, comprising:
a housing having an interior space for retention of retail merchandise therein;
an access door providing access to the interior space, the access door configured to be selectively locked closed relative to the housing to prevent unauthorized access to the retail merchandise carried in the interior space;
an input interface configured to receive customer input to effectuate a purchase of retail merchandise; and
a mounting arrangement configured to fixedly mount the dispensing unit to a retail display.

8. The retail merchandise dispensing unit of claim 7 wherein the mounting arrangement is configured to fixedly mount the dispensing unit to a peg board.

9. The retail merchandise dispensing unit of claim 7 wherein the mounting arrangement is configured to fixedly mount the dispensing unit to a retail shelf.

10. The retail merchandise dispensing unit of claim 7 wherein the mounting arrangement is configured to fixedly mount the dispensing unit to a slat wall.

11. The retail merchandise dispensing unit of claim 7 further comprising a biasing mechanism to bias merchandise within the housing from a secured position to an unsecured position.

12. The retail merchandise dispensing unit of claim 11 wherein the retail merchandise is inaccessible by a customer in the secured position and accessible by a customer in the unsecured position.

13. The retail merchandise dispensing unit of claim 12 wherein the merchandise is in an interior space of the housing in the secured position, and in a merchandise removal compartment in the unsecured position, wherein access from the interior space to the merchandise removal compartment is allowed and wherein access from the merchandise removal compartment to the interior space is prevented.

14. A loss prevention retail display, comprising:
a retail display structure supporting a retail merchandise retention area configured to carry retail merchandise therein;
an input system configured to receive a customer input; and
a biasing mechanism operable to bias retail merchandise out of the retail merchandise retention area and into a merchandise removal area in response to the customer input.

15. The loss prevention display of claim 14, wherein the retail display structure is a retail shelf

16. The loss prevention display of claim 14, wherein the retail display structure is a slatwall.

17. The loss prevention display of claim 14, further comprising an anti-theft system deactivation device.

18. The loss prevention display of claim 17, wherein the anti-theft system deactivation device is an RFID deactivating strip configured to deactivate an RFID transmitter affixed to an item of retail merchandise.

19. A method for configuring a retail merchandise environment with a retail merchandise dispensing system, the method comprising the steps of mounting a dispensing unit of the merchandise display system to a pre-existing retail display.

20. The method of claim 19 wherein the step of mounting includes mounting the merchandise dispensing system in proximity to items of retail merchandise that are in an unsecured state.

21. The method of claim 19 further comprising the step of securing merchandise within the dispensing unit in a secured state.

22. The method of claim 19 further comprising the step of removing retail merchandise containment structures from a location of the retail display, and placing a dispensing unit in the location.

23. The method of claim 21, further comprising the step of affixing an indicator to at least one item of the merchandise that indicates that the item has been paid for.

24. The method of claim 23, further comprising the step of deactivating the indicator within the dispensing unit.

25. The method of claim 23, wherein the indicator is at least one of an RFID transmitter or an adhesive label.
